(19) United States
(12) Patent Application Publication
(10) Pub. No.: US 2007/0179011 A1
(43) Pub. Date: Aug. 2, 2007

(54) Variable gear ratio steering apparatus for automobile

(75) Inventors: Jung-rak Choi, Yongin-si (KR); Byoungkuk Kim, Songpa-gu (KR)

Correspondence Address: LAHIVE & COCKFIELD, LLP, ONE POST OFFICE SQUARE, BOSTON, MA, 02109-2127, US

(73) Assignee: Mando Corporation, Pyeongtaek-si (KR)

(21) Appl. No.: 11/369,583

(22) Filed: Mar. 7, 2006

(30) Foreign Application Priority Data
Jan. 27, 2006 (KR) 2006-9016

(51) Int. Cl. F16H 57/08

(52) U.S. Cl. 475/331

(57) ABSTRACT

A variable gear ratio steering apparatus for an automobile includes an input shaft connected to a steering wheel; a sun gear coaxially formed with the input shaft while enclosing the input shaft; a first pair of planet gears externally meshing with the sun gear; a second pair of planet gears externally meshing with the sun gear; a first carrier coupled to the input shaft while connecting the first pair of planet gears; a second carrier adapted to rotate relative to the input shaft while connecting the second pair of planet gears; a ring gear internally meshing with the first and second pairs of planet gears; and an input shaft connected to the ring gear. The second carrier is inserted into the first carrier while being supported by a compression means so that the second carrier can rotate relative to the input shaft. This reduces backlash.

### RELATED APPLICATION

This application claims convention priority to Korean patent appln. No. 2006-0009016 filed on Jan. 27, 2006, the content of which is incorporated by reference.

### FIELD OF THE INVENTION

The present invention relates to a variable gear ratio steering apparatus for an automobile. More particularly, the present invention relates to a variable gear ratio steering apparatus for an automobile having a planetary gear system including a sun gear, a first carrier, and a second carrier inserted into the first carrier while being supported by a compression means so that the second carrier can make a relative rotation about the sun gear, in order to reduce the backlash.

### BACKGROUND OF THE INVENTION

As generally known in the art, a planetary gear system includes a sun gear, a planet gear externally meshing with the sun gear while being supported by a carrier, and a ring gear internally meshing with the planet gear. The planetary gear system may have a simpler structure, if necessary. The sun, planet, and ring gears may act as stationary, input, and output members, respectively, so that the reduction ratio (or overdrive ratio) can be easily varied. For these reasons, planetary gear systems are used in various apparatuses, particularly variable gear ratio steering apparatuses for automobiles.

In planetary gear systems, a backlash exists between cogs of the sun gear and cogs of the planet gear, as well as between cogs of the planet gear and cogs of the ring gear.

The backlash refers to a gap between adjacent cogs, more particularly, a space created behind meshing cogs when cogs of a gear mesh with cogs of another gear.

Meanwhile, in the case of a gear system having driving and following gears meshing with each other, there is no problem when the speed of the driving and following gears is constant. However, when the speed is not constant for some reasons, the backlash may generate noise.

This is because, before cogs of the driving gear completely disengage from cogs of the following gear, other cogs of the following gear collide with rear portions of cogs of the driving gear and generate noise.

The noise resulting from the backlash in a steering apparatus of an automobile causes discomfort during steering and worsens as cogs are worn down more and more.

Conventional methods for reducing the backlash include a static method, as shown in FIG. 1a, of moving gears, the distance between centers of which is fixed, in the axial or diametrical direction and fixing the distance between centers; a method of adjusting the distance between centers and fixing it; and a dynamic method, as shown in FIG. 1b, of adjusting the distance between centers by means of elastic force of an elastic body.

However, such conventional methods have a problem in that it is impossible to apply them to planetary gear systems. This is because, if the distance between centers of the sun and planet gears is reduced to decrease the backlash between them, the backlash between the planet and ring gears increases. On the other hand, if the distance between axes of the planet and ring gears is reduced to decrease the backlash between them, the backlash between the sun and planet gears increases.

In summary, it is impossible to reduce both the backlash between the sun and planet gears and that between the planet and ring gears according to the prior art.

### SUMMARY OF THE INVENTION

Accordingly, the present invention has been made to solve the above-mentioned problems occurring in the prior art, and an object of the present invention is to provide a variable gear ratio steering apparatus for an automobile having a planetary gear system including a sun gear, a first carrier, and a second carrier inserted into the first carrier while being supported by a compression means so that the second carrier can make a relative rotation about an input shaft, in order to reduce the backlash.

In order to accomplish this object, there is provided a planetary gear system including a sun gear; a plurality of planet gears externally meshing with the sun gear; a first link for connecting first and second planet gears of the plurality of planet gears; a second link having an end connected to a third planet gear of the plurality of planet gears while being able to rotate relative to the first link; and a ring gear internally meshing with the plurality of planet gears.

In accordance with another aspect of the present invention, there is provided a variable gear ratio steering apparatus for an automobile including an input shaft connected to a steering wheel; a sun gear coaxially formed with the input shaft while enclosing the input shaft; a first pair of planet gears externally meshing with the sun gear; a second pair of planet gears externally meshing with the sun gear; a first carrier coupled to the input shaft while connecting the first pair of planet gears; a second carrier adapted to rotate relative to the input shaft while connecting the second pair of planet gears; a ring gear internally meshing with the first and second pairs of planet gears; and an input shaft connected to the ring gear.

### BRIEF DESCRIPTION OF THE DRAWINGS

The above and other objects, features and advantages of the present invention will be more apparent from the following detailed description taken in conjunction with the accompanying drawings, in which:

FIGS. 1a and 1b briefly show conventional methods for reducing the backlash, respectively;

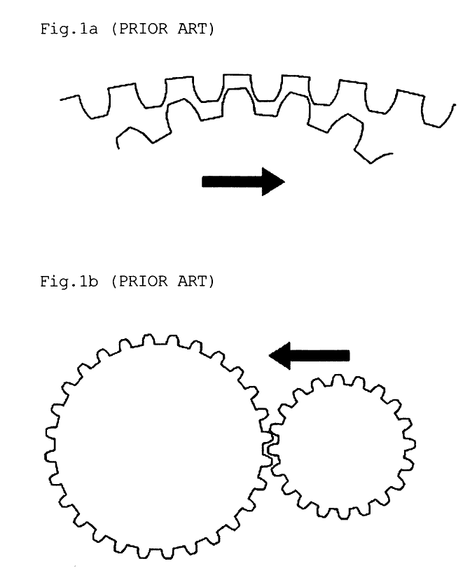

FIG. 2 is a perspective view showing a planetary gear system according to a first embodiment of the present invention;

FIGS. 3a and 3b are sectional views showing a planetary gear system according to a first embodiment of the present invention, when a backlash exists and when the backlash is reduced, respectively;

FIG. 4 is a partial sectional view showing a variable gear ratio steering apparatus for an automobile according to a second embodiment of the present invention;

FIG. 5 is an exploded perspective view showing major parts of a variable gear ratio steering apparatus for an automobile according to a second embodiment of the present invention;

FIGS. 6a and 6b are sectional views taken along line A-A of FIG. 4; and

FIGS. 7a and 7b are sectional views taken along line B-B of FIG. 4.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

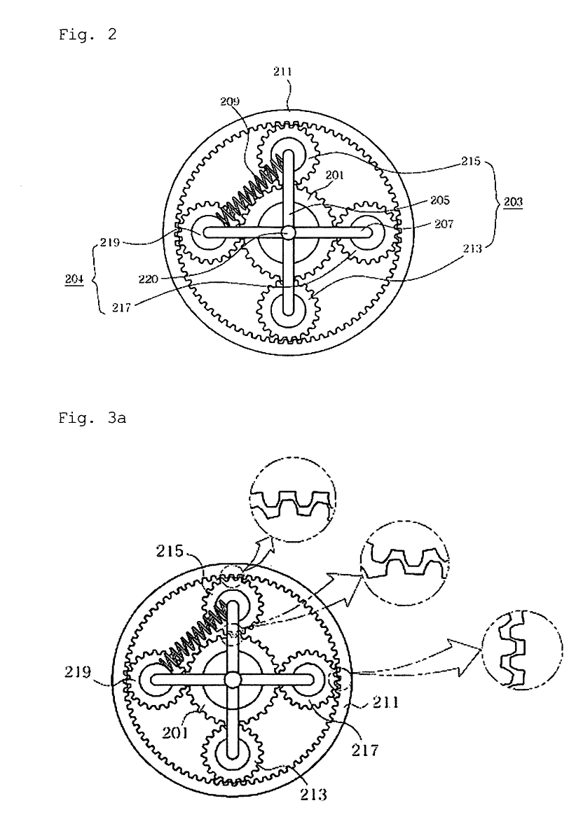

FIG. 2 is a perspective view showing a planetary gear system according to a first embodiment of the present invention.

As shown in FIG. 2, a planetary gear system according to a first embodiment of the present invention includes a sun gear 201; a first pair of planet gears 203; a second pair of planet gears 204; a first link 205; a second link 207; an elastic member 209; and a ring gear 211.

The first pair of planet gears 203 include first and second planet gears 213 and 215, and the second pair of planet gears 204 include third and fourth planet gears 217 and 219. If necessary, the planetary gear system according to the first embodiment of the present invention may include only three planet gears without the fourth planet gear 219. Alternatively, the system may include at least one additional planet gear.

The first link 205 connects the first and second planet gears 213 and 215 to each other, and the second link 207 connects the third and fourth planet gears 217 and 219 to each other. The middle portion of the second link 207 is connected to the first link 205 via a coupling pin 220 so that the second link can rotate relative to the first link.

When fewer planet gears are used, e.g. when the fourth planet gear 219 is omitted, an end of the second link 207 is connected to the third planet gear 217 and the other end thereof is connected to the first link 205 in such a manner that it can rotate relative to the first link 205.

The elastic member 209 is made of a tensile or compression spring, for example, and is positioned between the first and second links 205 and 207 so that they can be moved towards or away from each other.

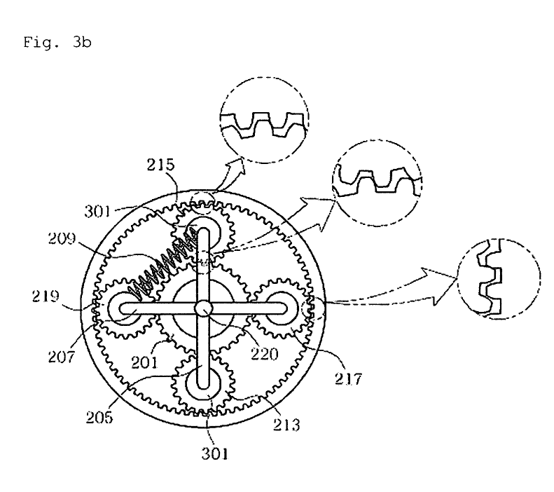

FIGS. 3a and 3b are sectional views showing the planetary gear system according to the first embodiment of the present invention, when a backlash exists and when the backlash is reduced, respectively.

The process of reducing the backlash in the planetary gear system according to the first embodiment of the present invention will now be described with reference to FIGS. 3a and 3b.

It is assumed that, as shown in FIG. 3a, a backlash initially exits between the sun gear 201 and the first and second planet gears 213 and 215, as well as between the sun gear 201 and the third and fourth planet gears 217 and 219. In addition, a backlash also exists between the ring gear 211 and the first and second planet gears 213 and 215, as well as between the ring gear 211 and the third and fourth planet gears 217 and 219.

When the elastic force of the elastic member 209 acts on the first and second links 205 and 207 and rotates the first link 205 clockwise about the coupling pin 220, as shown in FIG. 3b, the first and second planet gears 213 and 215 revolve while spinning clockwise about respective rotation shafts 301. As a result, cogs of the first and second planet gears 213 and 215 mesh with cogs of the ring gear 211.

More particularly, cogs of the first and second planet gears 213 and 215, which have disengaged from cogs on opposite sides of the ring gear 211, come to mesh with cogs on one side of the ring gear 211, when the first and second planet gears 213 and 215 rotate clockwise as a result of clockwise rotation of the first link 205. In addition, cogs of the first and second planet gears 213 and 215, which have disengaged from cogs on opposite sides of the sun gear 201, come to mesh with cogs on one side of the sun gear 201 as a result of clockwise rotation.

When the second link 207 makes a relative rotation in the counterclockwise direction, cogs of the third and fourth planet gears 217 and 219 mesh with cogs on one side of the sun and ring gears 201 and 211, respectively.

It is to be noted that cogs of the first and second planet gears 213 and 215 mesh with cogs of the sun and ring gears 201 and 211 in the clockwise direction about the rotation shafts 301, while cogs of the third and fourth planet gears 217 and 219 mesh with cogs of the sun and ring gears 201 and 211 in the counterclockwise direction.

Therefore, when the sun gear 201 rotates clockwise, cogs of the sun gear 201 mesh with cogs of the first and second planet gears 213 and 215 sooner than cogs of the third and fourth planet gears 217 and 219 and rotate accordingly. This guarantees smooth and robust meshing and avoids noise resulting from a backlash.

When the sun gear 201 rotates counterclockwise, cogs of the sun gear 201 mesh with cogs of the third and fourth planet gears 217 and 219 sooner than cogs of the first and second planet gears 213 and 215 and rotate accordingly.

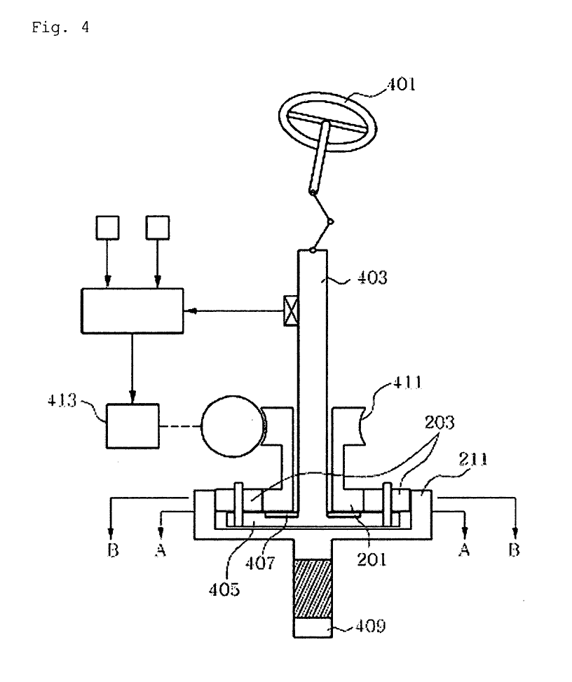

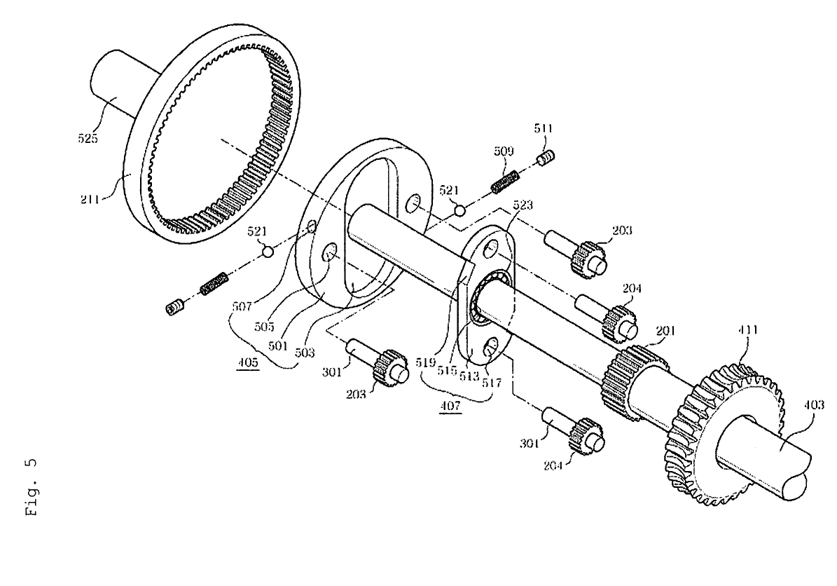

FIG. 4 is a partial sectional view showing a variable gear ratio steering apparatus for an automobile according to a second embodiment of the present invention, and FIG. 5 is an exploded perspective view showing major parts of the variable gear ratio steering apparatus for an automobile according to the second embodiment of the present invention.

As shown in FIGS. 4 and 5, a variable gear ratio steering apparatus for an automobile according to a second embodiment of the present invention includes an input shaft 403 connected to a steering wheel 401; a sun gear 201 coaxially formed with the input shaft 403 to enclose it; first and second pairs of planet gears 203 and 204 externally meshing with the sun gear 201; a first carrier 405 connected to the input shaft 403 to connect the first pair of planet gears 203 to each other; a second carrier 407 adapted to rotate relative to the input shaft 403 while connecting the second pair of planet gears 204 to each other; a ring gear 211 internally meshing with the first and second pairs of planet gears 203 and 204; and an output shaft 409 connected to the ring gear 211.

The input shaft 403 has an upper end connected to the steering wheel 401 and a lower end fixedly connected to the first carrier 405, as will be described later. When the driver rotates the steering wheel 401, the input shaft 403 and the first carrier 405 rotate accordingly.

The sun gear 201 is coaxially formed with the input shaft 403 to enclose it. If necessary, the sun gear 201 may have a worm wheel 411 formed on the top thereof, in order to receive power from various actuators, including a motor 413.

The first carrier 405 includes a first carrier body 501, a mounting groove 503, first coupling holes 505, and insertion holes 507.

The first carrier body 405 has the shape of a disk with a predetermined diameter and preferably has an overall thickness larger than that of the second carrier 407 so that the second carrier 407 can be inserted into the first carrier 405, but the relative size is not limited to that herein. The lower end of the input shaft 403 is fixedly coupled to the center of the first carrier body 405 so that the first carrier 405 rotates together with rotation of the input shaft 403.

The mounting groove 503 extends a predetermined distance from the center of the first carrier body 501 with a predetermined depth so that the second carrier 407 can be inserted into the first carrier 405. The mounting groove 503 has a width larger than that of the second carrier 407 so that the second carrier 407, when inserted into the mounting groove 503, can rotate about the input shaft 403 relative to the first carrier 405 in a space created by the difference in width.

The first coupling holes 505 are formed on the first carrier body 501 and face each other about the input shaft 403 so that the rotation shafts 301 of the first pair of planet gears 203 are inserted therein, respectively. Preferably, bearings may be positioned between the inner peripheral surface of the first coupling holes 505 and the outer peripheral surface of the rotation shafts 301 of the first pair of planet gears 203.

The insertion holes 507 extend from one side of the inner peripheral surface of the mounting grooves 503 in the outward direction. Compression springs 509 are inserted into the insertion holes 507 in such a manner that an end of the compression springs 509 makes contact with the second carrier 407. The compression springs 509 apply pressure to the second carrier 407 so that it can rotate relative to the first carrier 405. If necessary, the compression springs 509 may be replaced with any elastic substance, including rubber and synthetic rubber.

Preferably, steel balls 521 are positioned between the compression springs 509 and the second carrier 407, in order to prevent the compression springs 509 from being worn down by friction between an end of the compression springs 509 and the second carrier 407, as well as maintain stable contact between the compression springs 509 and the second carrier 407 regardless of external impact.

In order to ensure a sufficient length of the compression springs 509, the insertion holes 507 are preferably slanted relative to a virtual line connecting the first coupling holes 505, rather than being parallel to it.

The insertion holes 507 have female screws formed on their inner peripheral surface and are provided with adjustment means 511, which have male screws formed on its end to engage with the female screws. The adjustment means 511 are used to adjust the degree of compression of the compression springs 509 and the resulting pressure acting on the second carrier 407. The adjustment means 511 are preferably headless wrench bolts, but the type is not limited to that herein.

The second carrier 407 includes a second carrier body 513, an input shaft through-hole 515, and second coupling holes 517.

The second carrier body 513 is an elongated plate with a predetermined thickness. The second carrier body 513 has an input shaft through-hole 515 formed at the center thereof, through which the input shaft 403 extends through for coupling, and second coupling holes 517 spaced a predetermined distance from the center of the input shaft through-hole 515 in the vertical direction so that the rotation shafts 301 of the second pair of planet gears 204 are inserted therein, respectively.

The second carrier body 513 has V-shaped recesses 519 formed on the outer peripheral surface thereof, and the steel balls 521 are positioned between an end of the compression springs 509 and the recesses 519, respectively. If necessary, the steel balls 521 may be replaced with another type of media made of plastic or ceramic, for example, in a shape other than a sphere.

The input shaft through-hole 515 is formed at the center of the second carrier 513, and bearing 523 are preferably positioned between the inner peripheral surface of the input shaft through-hole 515 and the outer peripheral surface of the input shaft 403.

The second coupling holes 517 are spaced a predetermined distance from the center of the second carrier body 513 in the vertical direction so that the rotation shafts 301 of the second pair of planet gears 204 are inserted therein, respectively. If necessary, bearings may be positioned between the inner peripheral surface of the second coupling holes 517 and the outer peripheral surface of the rotation shafts 301 of the second pair of planet gears 204.

The first and second pairs of planet gears 203 and 204 mesh with the inner peripheral surface of the ring gear 211, and an output shaft 525 is coupled to the lower end of the ring gear 211. If necessary, the output shaft 525 may be integrally formed with the ring gear 211.

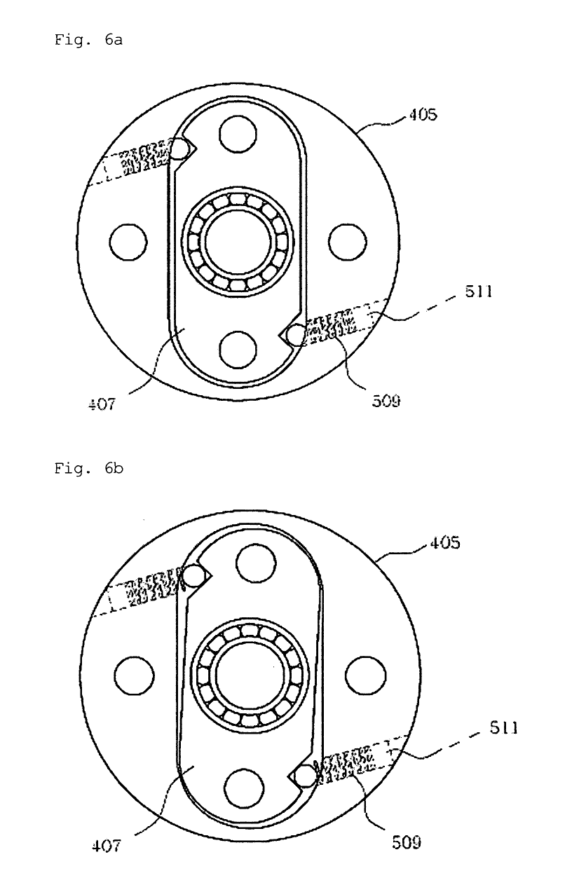

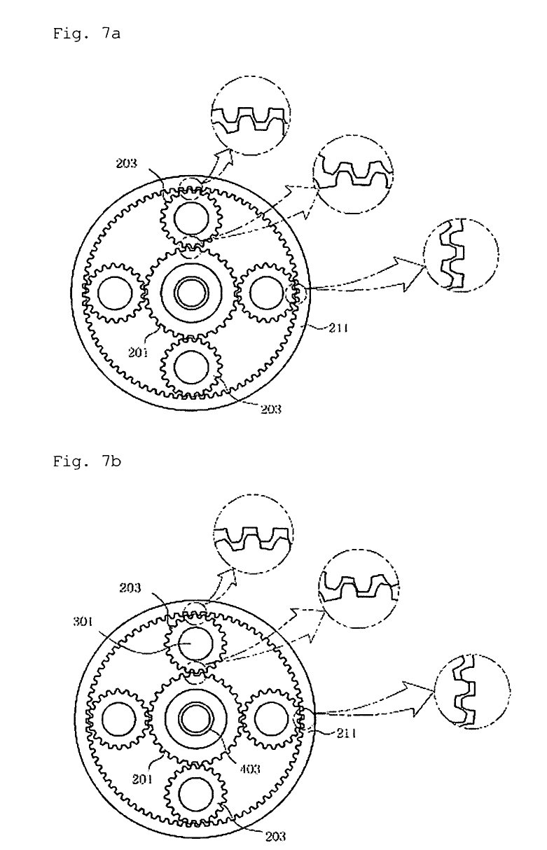

FIGS. 6a and 6b are sectional views taken along line A-A of FIG, when a backlash exists and when the backlash is reduced, respectively. FIGS. 7a and 7b are sectional views taken along line B-B of FIG. 4, when a backlash exists and when the backlash is reduced, respectively.

The operation of the variable gear ratio steering apparatus for an automobile according to the second embodiment of the present invention will now be described with reference to FIGS. 6a, 6b, 7a, and 7b.

It is assumed that, as shown in FIGS. 6a and 7a, a backlash exits between the sun gear 201 and the first pair of planet gears 203, as well as between the first pair of planet gears 203 and the ring gear 211.

When the adjustment means 511 are rotated to apply pressure to the compression springs 509, as shown in FIGS. 6b and 7b, the second carrier 407 rotates clockwise about the input shaft 403. As a result, cogs of the first pair of planet gears 203 mesh with cogs on one side of the ring gear 211.

More particularly, cogs of the first pair of planet gears 203, which have disengaged from cogs on opposite sides of the ring gear 211, come to mesh with cogs on one side of the ring gear 211, when the first pair of planet gears 203 revolve while spinning clockwise as a result of clockwise rotation of the second carrier 407. In addition, cogs of the first pair of planet gears 203, which have disengaged from cogs on opposite sides of the sun gear 201, move in the clockwise direction and mesh with cogs on one side of the sun gear 201, when the first pair of planet gears 203 rotate clockwise.

Therefore, when the sun gear 201 rotates clockwise, cogs of the sun gear 201 mesh with cogs of the first pair of planet gears 203 before cogs of the second pair of planet gears 204 and rotate accordingly. This avoids noise resulting from a backlash, as has been described in detail with reference to the first embodiment.

As mentioned above, the variable gear ratio steering apparatus for an automobile according to the present invention has a second carrier inserted into a first carrier while being supported by a compression means so that the second carrier can make a relative rotation about an input shaft. This reduces backlash.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A variable gear ratio steering apparatus for an automobile comprising:
an input shaft connected to a steering wheel;
a sun gear coaxially formed with the input shaft while enclosing the input shaft;
a first pair of planet gears externally meshing with the sun gear;
a second pair of planet gears externally meshing with the sun gear;
a first carrier coupled to the input shaft while connecting the first pair of planet gears;
a second carrier adapted to rotate relative to the input shaft while connecting the second pair of planet gears;
a ring gear internally meshing with the first and second pairs of planet gears; and
an output shaft connected to the ring gear.

2. The variable gear ratio steering apparatus for an automobile as claimed in claim 1, wherein a mounting groove is formed on the first carrier, and the second carrier is inserted into the mounting groove.

3. The variable gear ratio steering apparatus for an automobile as claimed in claim 1, wherein the first and second carriers are connected to each other by an elastic member.

4. The variable gear ratio steering apparatus for an automobile as claimed in claim 2, wherein the first carrier has a compression means, and the compression means apply a predetermined pressure to the second carrier.

5. The variable gear ratio steering apparatus for an automobile as claimed in claim 4, wherein the first carrier has an insertion hole extending from an inner peripheral surface of the mounting groove to an outer peripheral surface of the mounting groove, and the compression means is inserted into the insertion hole.

6. The variable gear ratio steering apparatus for an automobile as claimed in claim 4, wherein a recess is formed on an outer peripheral surface of the second carrier with a predetermined depth, and a steel ball is positioned between the compression means and the recess.

7. The variable gear ratio steering apparatus for an automobile as claimed in claim 5, wherein the insertion hole is adapted to communicate with an outside of the carrier, a female screw is formed on an inner peripheral surface of the insertion hole, and an adjustment means is provided with a male screw engaging with the female screw.

8. The variable gear ratio steering apparatus for an automobile as claimed in claim 7, wherein the compression means is an elastic body.
